(19) United States
(12) Patent Application Publication
(10) Pub. No.: US 2025/0168499 A1
(43) Pub. Date: May 22, 2025

(54) OBSERVATION ASSISTANCE APPARATUS, OBSERVATION ASSISTANCE METHOD, AND COMPUTER-READABLE RECORDING MEDIUM

(71) Applicant: NEC Corporation, Minato-ku, Tokyo (JP)

(72) Inventors: Yumiko Urasawa, Tokyo (JP); Kenta Iseki, Tokyo (JP)

(73) Assignee: NEC Corporation, Minato-ku, Tokyo (JP)

(21) Appl. No.: 18/841,019

(22) PCT Filed: Mar. 9, 2023
(86) PCT No.: PCT/JP2023/009084

§ 371 Date: Aug. 23, 2024

(30) Foreign Application Priority Data
Mar. 28, 2022 (JP) 2022-051790

(51) Int. Cl. H04N 23/60; G06T 15/60

(52) U.S. Cl. CPC H04N 23/64; G06T 15/60

(57) ABSTRACT

An observation assistance apparatus for supporting generation of control instruction information used for observation of a mobile body includes: a target region quasi-image generation unit that generates a target region quasi-image that shows a target region, which is estimated when the target region is captured from a viewpoint of a mobile body moving along a path, and a control instruction information generation unit that generates control instruction information for causing the mobile body to observe an actual observation image of the target region equivalent to the target region quasi-image, if the target region quasi-image is selected by an operator, based on mobile body position information indicating a position of the mobile body and mobile body direction information indicating a direction of the mobile body that were used when the selected target region quasi-image was generated.

### TECHNICAL FIELD

The technical field relates to an observation assistance apparatus and an observation assistance method for assisting observation that uses a mobile body moving along a path, and further relates to a computer-readable recording medium in which a program for realizing the observation assistance apparatus and the observation assistance method is recorded.

### BACKGROUND ART

When an operator shoots a desired image of a target region using an image capture apparatus mounted in an artificial satellite, the operator imagines an image of the target region estimated to be actually captured, and prepares an image capturing plan.

However, in order to imagine an image of the target region estimated to be actually captured by the image capture apparatus and prepare a plan, a position of an artificial satellite on a path, a direction that the artificial satellite at the position faces (orientation of the artificial satellite), a time when the artificial satellite will reach the position, and the like need to be taken into consideration.

For this reason, under the current circumstances, experienced and skilled operators are preparing plans. In other words, it is difficult for inexperienced operators to imagine an image of the target region estimated to be actually captured by the image capture apparatus and prepare an image capturing plan.

In addition, in order for an operator to capture a desired image of the target region, there is a need to generate control instruction information (a satellite command) for controlling the artificial satellite based on a prepared image capturing plan.

As a related technique, Patent Document 1 discloses an image capturing plan creating apparatus that extracts, from points of interest, points at which there has been a change, and captures an image with priority given to the extracted points. The image capturing plan creating apparatus in Patent Document 1 compares first captured image data captured by a flying body (artificial satellite) with second captured image data captured in the past, and sets image capturing priority based on the comparison result.

In addition, the image capturing plan creating apparatus in Patent Document 1 determines whether or not an image can be captured at an observation time. The image capturing plan creating apparatus in Patent Document 1 then creates an image capturing plan based on the image capturing priority and the determination result, converts the image capturing plan into a satellite command, and transmits the satellite command to the flying body.

### LIST OF RELATED ART DOCUMENTS

### Patent Document

Patent Document 1: Japanese Patent Laid-Open Publication No. 2015-028759

### SUMMARY OF INVENTION

### Problems to be Solved by the Invention

However, the image capturing plan creating apparatus in Patent Document 1 generates an image capturing plan for capturing an image of points (observation targets) extracted from the artificial satellite, but does not assist generation of a satellite command used for controlling image capturing of the artificial satellite.

That is to say, the image capturing plan creating apparatus in Patent Document 1 is not an apparatus that presents, to the operator in advance, a quasi-image equivalent to an image of a target region estimated to be actually captured by the image capture apparatus and generates a satellite command based on the presented quasi-image.

An example object of the present disclosure is to provide, as an aspect thereof, an observation assistance apparatus, an observation assistance method, and a computer-readable recording medium for assisting generation of control instruction information that is used for observation performed by a mobile body.

### Means for Solving the Problems

In order to achieve the example object described above, an observation assistance apparatus according to an example aspect includes:
a target region quasi-image generation unit that generates a target region quasi-image that shows a target region and is estimated to be obtained when an image of the target region is captured from a viewpoint of a mobile body that is equipped with an observation apparatus for observing the Earth's surface and moves along a path in a space above the Earth's surface; and
a control instruction information generation unit that generates, if the target region quasi-image is selected by an operator, control instruction information that is used for controlling at least a timing when the mobile body observes the target region, a position at which the mobile body performs observation, and a direction in which the mobile body performs observation, which are information for causing the mobile body to observe an actual observation image of the target region equivalent to the target region quasi-image, based on mobile body position information indicating a position of the mobile body and mobile body direction information indicating a direction of the mobile body that were used when the selected target region quasi-image was generated.

Also, in order to achieve the example object described above, an observation assistance method that is performed by a computer according to an example aspect includes:
a target region quasi-image generation step of generating a target region quasi-image that shows a target region and is estimated to be obtained when an image of the target region is captured from a viewpoint of a mobile body that is equipped with an observation apparatus for observing the Earth's surface and moves along a path in a space above the Earth's surface; and
a control instruction information generation step of generating, if the target region quasi-image is selected by an operator, control instruction information that is used for controlling at least a timing when the mobile body observes the target region, a position at which the mobile body performs observation, and a direction in which the mobile body performs observation, which are information for causing the mobile body to observe an actual observation image of the target region equivalent to the target region quasi-image, based on mobile body position information indicating a position of the mobile body and mobile body direction information indicating a direction of the mobile body that were used when the selected target region quasi-image was generated.

Furthermore, in order to achieve the example object described above, a computer-readable recording medium according to an example aspect includes a program recorded on the computer-readable recording medium, the program including instructions that cause the computer to carry out:
a target region quasi-image generation step of generating a target region quasi-image that shows a target region and is estimated to be obtained when an image of the target region is captured from a viewpoint of a mobile body that is equipped with an observation apparatus for observing the Earth's surface and moves along a path in a space above the Earth's surface; and
a control instruction information generation step of generating, if the target region quasi-image is selected by an operator, control instruction information that is used for controlling at least a timing when the mobile body observes the target region, a position at which the mobile body performs observation, and a direction in which the mobile body performs observation, which are information for causing the mobile body to observe an actual observation image of the target region equivalent to the target region quasi-image, based on mobile body position information indicating a position of the mobile body and mobile body direction information indicating a direction of the mobile body that were used when the selected target region quasi-image was generated.

### Effects of Invention

As an aspect, it is possible to assist generation of control instruction information that is used for observation performed by a mobile body.

### BRIEF DESCRIPTION OF THE DRAWINGS

FIG. 1 is a diagram for describing an example of the observation assistance apparatus.

FIG. 2 is a diagram of an example of a system that includes the observation assistance apparatus.

FIG. 3 is diagrams for describing generation of a target region quasi-image.

FIG. 4 is diagrams for describing generation of a target region quasi-image.

FIG. 5 is a diagram in which shadows are added to the target region quasi-image.

FIG. 6 is a diagram in which the content of control instruction information is displayed in a target region quasi-image.

FIG. 7 is a diagram for describing operations of the observation assistance apparatus.

FIG. 8 is a diagram for describing an example of a computer that realizes the observation assistance apparatus in the example embodiment, the modified example 1 and the modified example 2.

### EXAMPLE EMBODIMENT

Hereinafter, example embodiments will be described with reference to the drawings. Note that in the drawings described below, elements having the same functions or corresponding functions are denoted by the same reference numerals, and repeated description thereof may be omitted.

### EXAMPLE EMBODIMENT

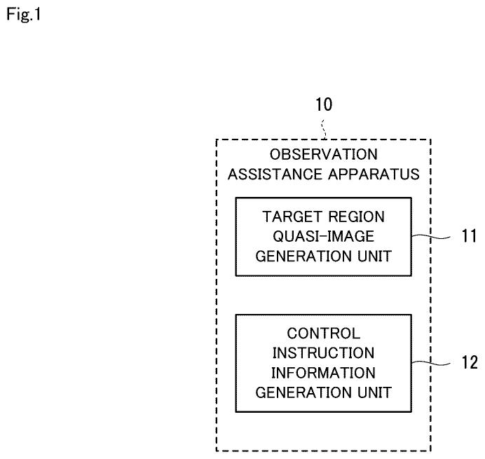

A configuration of an observation assistance apparatus according to an example embodiment will be described with reference to FIG. 1. FIG. 1 is a diagram for describing an example of the observation assistance apparatus.

### [Apparatus Configuration]

An observation assistance apparatus 10 shown in FIG. 1 is an apparatus that presents, to the operator in advance, a quasi-image equivalent to an image of a target region estimated to be actually captured by an image capture apparatus, and generates control instruction information based on the presented quasi-image. In addition, as shown in FIG. 1, the observation assistance apparatus 10 includes a target region quasi-image generation unit 11 and a control instruction information generation unit 12.

The target region quasi-image generation unit 11 generates a target region quasi-image that indicates a target region and is estimated to be obtained when an image of the target region is captured from a viewpoint of a mobile body that is equipped with an observation apparatus for observing the Earth's surface, and moves along a path in a space above the Earth's surface.

The mobile body moves along a preset path in a space above the Earth's surface. The mobile body is a flying body such as an artificial satellite or an unmanned aircraft. When the artificial satellite is an observation satellite or the like, the path is a satellite orbit, for example. In a case of an unmanned aircraft, the path is a flight route set by the operator in advance.

The observation apparatus is one of various sensors used for observing the Earth's surface, for example. In a case of an observation satellite, the observation apparatus is an optical sensor such as a camera or a mission device such as a SAR (Synthetic Aperture Radar).

When a target region quasi-image is selected by the operator, the control instruction information generation unit 12 generates control instruction information to be used for controlling at least a timing when the mobile body observes the target region, a position at which the mobile body performs observation, and a direction in which the mobile body performs observation, which are information for causing the mobile body to observe an actual observation image of the target region equivalent to the target region quasi-image, based on mobile body position information indicating the position of the mobile body and mobile body direction information indicating the direction of the mobile body that were used when the selected target region quasi-image was generated.

The mobile body position information is information such as the latitude and longitude of the location of the mobile body, and the altitude of the mobile body. The mobile body direction information is information such as an incident angle indicated by the position of the target region and the position of the mobile body, for example. The observation image is an image that is actually captured by the observation apparatus.

In a case where the mobile body is an observation satellite, the control instruction information is control information (satellite command) that is transmitted from a ground operation station (hereinafter, referred to as a “station”) to the artificial satellite. In a case where the mobile body is an unmanned aircraft, the control instruction information is control information for controlling the unmanned aircraft.

As described above, in the example embodiment, when the operator prepares a plan for observing an image of a desired target region using the observation apparatus mounted in the mobile body, it is possible to automatically generate control instruction information that includes information required for controlling the mobile body, simply by selecting a target region quasi-image of the target region that the operator desires to observe. As a result, it is possible even for an operator who is not experienced or skilled to easily generate control instruction information.

### [System Configuration]

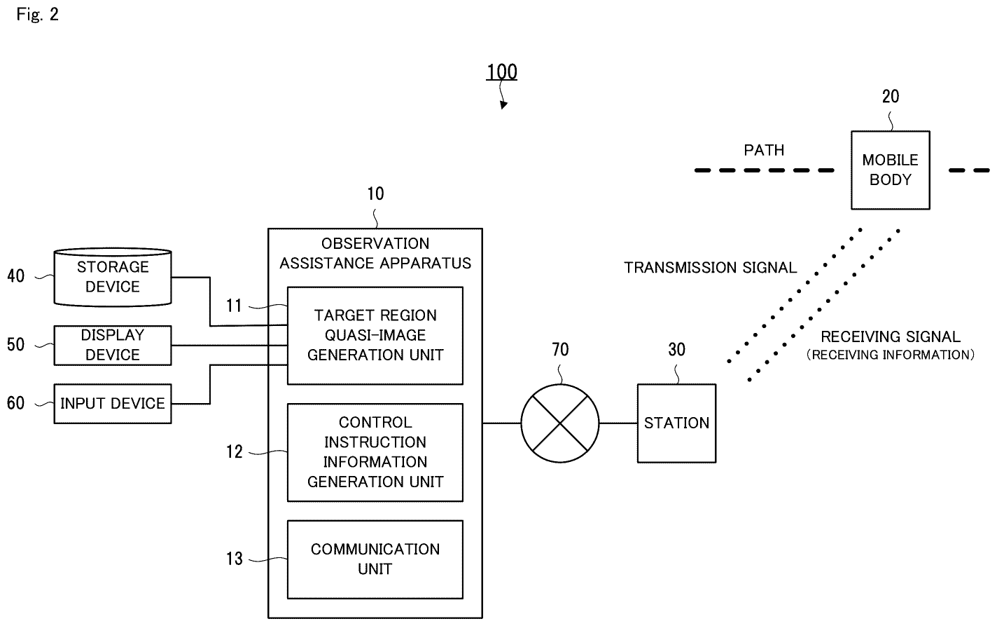

A configuration of the observation assistance apparatus 10 according to the example embodiment will be described in more detail. FIG. 2 is a diagram of an example of a system that includes the observation assistance apparatus.

As shown in FIG. 2, a system 100 includes the observation assistance apparatus 10, a mobile body 20, a station 30, a storage device 40, a display device 50, an input device 60, and a network 70.

The observation assistance apparatus 10 is an information processing apparatus such as a CPU (Central Processing Unit), a programmable device such as an FPGA (Field-Programmable Gate Array), a GPU (Graphics Processing Unit), a circuit in which one or more thereof are mounted, a server computer, a personal computer, or a mobile terminal.

The mobile body 20 is a flying body such as an artificial satellite or an unmanned aircraft that moves along a preset path in a space above the Earth's surface. The artificial satellite is, for example, an observation satellite that observes a planet such as the Earth. The unmanned aircraft is a drone or the like.

Note that a description will be given below assuming that the mobile body 20 is an observation satellite, and the observation apparatus is an optical sensor such as a camera.

In a case where the mobile body 20 is an observation satellite, the station 30 is a transmission/reception station that has a function of generating a transmission signal that includes a satellite command and transmitting the generated transmission signal to the observation satellite and a function of receiving information to be received such as telemetry data or mission data from the observation satellite.

The mission data is, for example, observation data (such as an observation image). The observation data is, for example, an image that is equivalent to the target region quasi-image selected by the operator, and is obtained when the mobile body 20 actually observes the target region.

The storage device 40 is a circuit or the like that includes a database, a server computer, and a memory. The storage device 40 stores at least information such as path information regarding the path of the observation satellite, and map information. In the example in FIG. 2, the storage device 40 is provided outside of the observation assistance apparatus 10, but may be provided inside of the observation assistance apparatus 10. Note that the map information may be obtained from a site that provides various maps through a web browser.

The display device 50 is a display device that uses a liquid crystal display, an organic EL (Electro Luminescence) display, or a CRT (Cathode Ray Tube), for example. The input device 60 is a device such as a mouse, a keyboard, and a touch panel.

The network 70 is an ordinary network constructed using a communication line such as the Internet, a LAN (Local Area Network), a dedicated line, a phone line, an intranet, a mobile communication network, Bluetooth (registered trademark), or WiFi (Wireless Fidelity).

The observation assistance apparatus 10 will be described in detail.

As shown in FIG. 2, the observation assistance apparatus 10 includes the target region quasi-image generation unit 11, the control instruction information generation unit 12, and a communication unit 13.

The target region quasi-image generation unit 11 generates a target region quasi-image that is estimated to be obtained when an image of the target region is captured from a viewpoint of the observation apparatus (optical sensor) mounted in the observation satellite (the mobile body 20). That is to say, it is possible to generate an image (quasi-image) that gives a feeling as if the operator himself or herself has boarded the observation satellite and shot an image of the target region using a camera.

Specifically, first, the target region quasi-image generation unit 11 obtains information indicating a viewpoint of the optical sensor mounted in the observation satellite for capturing an image of the target region, the information having been input by the operator using the display device 50 and the input device 60. The information indicating a viewpoint includes mobile body position information and mobile body direction information.

Next, the target region quasi-image generation unit 11 uses, as input, the mobile body position information, the mobile body direction information, and map information of the target region, to generate a target region quasi-image using a simulator that uses a library such as CESIUM as an existing simulator, and displays the generated target region quasi-image on the display device 50.

The simulator may be provided in the target region quasi-image generation unit 11. Alternatively, a configuration may also be adopted in which an apparatus that has a function of a simulator is provided outside of the target region quasi-image generation unit 11 and is used for performing simulation.

The map information is two-dimensional or three-dimensional map information. The map information includes two-dimensional or three-dimensional information regarding a building or the like. The target region quasi-image is a two-dimensional or three-dimensional map image. The target region quasi-image includes not only terrain but also an image of a building and the like.

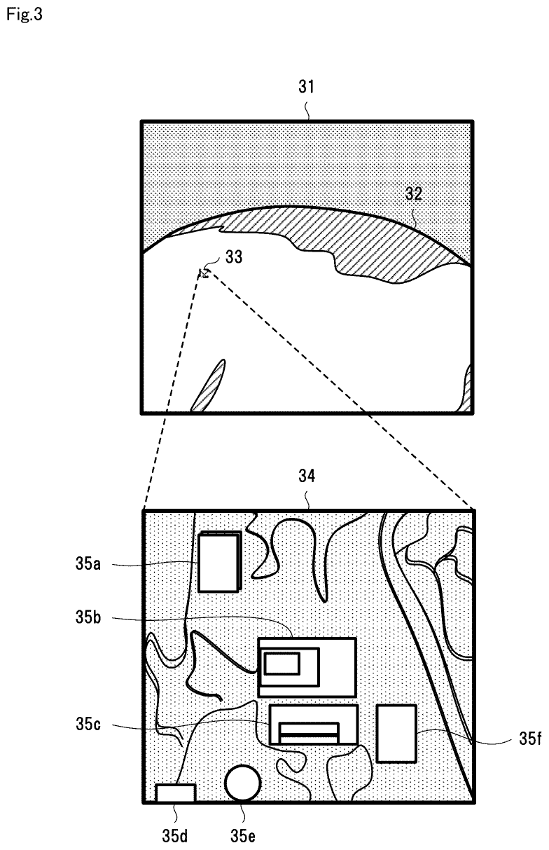

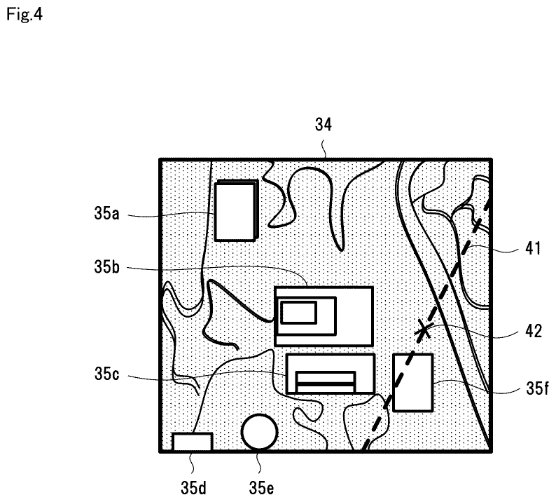

Generation of a target region quasi-image will be described with reference to FIGS. 3 and 4. FIGS. 3 and 4 are diagrams for describing generation of a target region quasi-image.

First, the target region quasi-image generation unit 11 displays, with the use of a simulator that uses a library such as CESIUM as an existing simulator, for example, an image of the entirety or a portion of the Earth (or a planet) on the display device 50 in order to prompt the operator to designate a target region, at the start of an operation. In the example in FIG. 3, an image 32 showing a portion of the Earth is displayed in an image 31.

Assume that, for example, the operator references the image 31 displayed on the display device 50 and designates an image 33 (area surrounded by the broken line) corresponding to the target region in the image 32 of a portion of the Earth, using the input device 60 such as the mouse.

The target region quasi-image generation unit 11 then enlarges the designated image 33, for example, using a simulator that uses a library such as CESIUM as an existing simulator, and displays an image 34 corresponding to the enlarged target region on the display device 50. An image corresponding to terrain of the target region (a river, a mountain, a road, etc.) and images corresponding to target region buildings 35a to 35f are displayed in the image 34, for example.

Next, if the image 34 displayed on the display device 50 is not a desired target region quasi-image, the operator moves the viewpoint using the input device 60 such as the mouse. When an image of a target building is not properly captured due to being obstructed by another building or the like, for example, the viewpoint is moved to a position at which an image of the target building can be properly captured.

As shown in the image 34 in FIG. 4, for example, a path 41 (broken line) and a viewpoint 42 (sign x) are displayed, and the viewpoint 42 is moved on the path 41 using the input device 60 such as the mouse. The target region quasi-image generation unit 11 then generates a new target region quasi-image as viewed from the viewpoint 42, based on mobile body position information and mobile body direction information that correspond to the viewpoint 42 and map information of the target region.

Moreover, in addition to movement of the viewpoint, the orientation of the observation satellite (a direction in which an image of the target region is captured) may also be changed. In addition, in a case where the optical sensor mounted in the observation satellite has a magnification change (zoom) function, magnification may be changed using the input device 60.

Furthermore, an image illustrating the observation satellite may be displayed at the viewpoint 42. In that case, a configuration may be adopted in which the observation direction of the observation satellite can be changed using the input device 60 such as the mouse by performing an operation on the image of the observation satellite.

Note that, as in FIG. 4, the viewpoint may be moved without displaying the path 41 (broken line) and the viewpoint 42 (sign x). In that case, a configuration may be adopted in which the viewpoint is moved based on a series of mouse operations set in advance using the input device 60 such as the mouse, and a target region quasi-image is newly generated.

Next, when a newly generated target region quasi-image displayed on the display device 50 is a target region quasi-image desired by the operator, the operator selects the newly generated target region quasi-image using the input device 60 such as the mouse.

As described above, the observation satellite moves on the path, and thus an image of the target region is captured from a position on the path. Therefore, an image of the target region cannot be captured from all directions. That is to say, the direction in which an image of the target region can be captured is restricted, and thus it is not necessarily possible to capture a target region quasi-image desired by the operator.

In view of this, the target region quasi-image generation unit 11 generates a quasi-image of the target region captured from a viewpoint of the optical sensor mounted in the observation satellite, that is to say, a target region quasi-image corresponding to the target region in a range in which an image can be captured by the optical sensor, and presents the quasi-image to the operator.

As such, the operator can move the viewpoint until a desired target region quasi-image is obtained. That is to say, a target region quasi-image is generated in real time for each viewpoint and presented to the operator, and thus the operator can intuitively obtain a desired target region quasi-image.

When a target region quasi-image is selected by the operator, the control instruction information generation unit 12 generates control instruction information based on mobile body position information and mobile body direction information that were used when the selected target region quasi-image was generated.

Specifically, first, the control instruction information generation unit 12 obtains mobile body position information and mobile body direction information that were used when the selected target region quasi-image was generated.

Next, the control instruction information generation unit 12 calculates a position and a direction for the observation satellite to capture an image of the target region, which are to be used for control instruction information, based on the mobile body position information and the mobile body direction information that were used when the selected target region quasi-image was generated.

In addition, the control instruction information generation unit 12 calculates a timing when the observation satellite can capture an observation image equivalent to the selected target region quasi-image, and the timing is to be used for control instruction information. As the timing, a time and date is calculated at which the observation satellite can capture an image from the above calculated position and direction for capturing an image. The control instruction information generation unit 12 then generates control instruction information and outputs the control instruction information to the communication unit 13. Alternatively, the control instruction information generation unit 12 stores the control instruction information in the storage device 40.

The communication unit 13 obtains the generated control instruction information from the control instruction information generation unit 12 and transmits the generated control instruction information to the station 30 via the network 21. The station 30 then transmits, to the observation satellite, a transmission signal modulated using the control instruction information.

### Modified Example 1

In Modified Example 1, in order to bring a target region quasi-image close to an observation image that is actually captured, shadows are added to the target region quasi-image.

Specifically, the target region quasi-image generation unit 11 first generates a target region quasi-image that is estimated to be obtained when an image of the target region is captured from a viewpoint of the optical sensor mounted in the observation satellite.

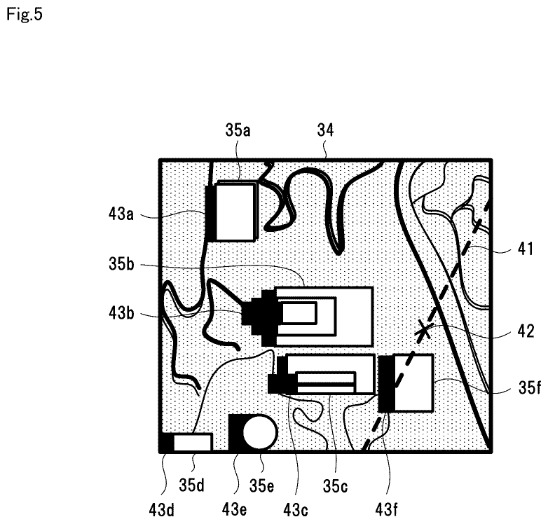

Next, as shown in FIG. 5, the target region quasi-image generation unit 11 adds shadows to the generated target region quasi-image, for example, using a simulator that uses a library such as CESIUM as an existing simulator. FIG. 5 is a diagram in which shadows are added to the target region quasi-image.

The simulator adds shadow images 43a to 43f (black portions in FIG. 5) to the target region quasi-image using a timing when the generated target region quasi-image can be observed, insolation information indicating the altitude and amplitude of the sun in the target region at the timing, and three-dimensional map information of the target region.

In addition, the simulator may add shadow images to the target region quasi-image using the timing when the generated target region quasi-image can be observed, weather information indicating weather in the target region at the timing (information indicating the degree of cloudiness, hours of daylight, and the like), and three-dimensional map information of the target region.

Furthermore, the simulator may add shadow images to the target region quasi-image using the timing when the generated target region quasi-image can be observed, the insolation information and the weather information at the timing, and three-dimensional map information of the target region.

As described above, according to Modified Example 1, by adding shadow images to the target region quasi-image, the target region quasi-image is brought closer to an observation image that is actually captured, and thus the operator can further intuitively reference the target region quasi-image.

### Modified Example 2

In Modified Example 2, control instruction information is displayed on the display device 50 along with a target region quasi-image. Specifically, the target region quasi-image generation unit 11 obtains control instruction information generated by the control instruction information generation unit 12, and displays the content of the control instruction information on the display device 50 along with the target region quasi-image.

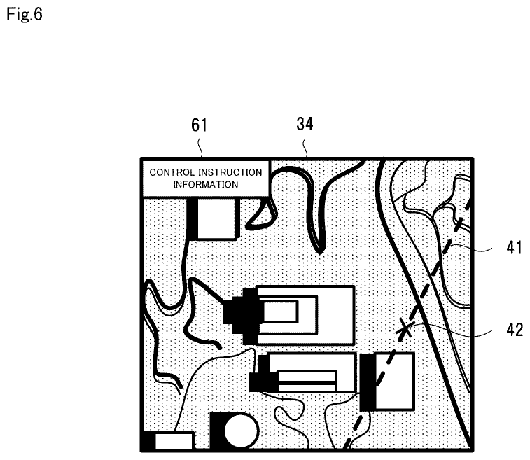

FIG. 6 is a diagram in which the content of control instruction information is displayed in a target region quasi-image. As in FIG. 6, by displaying the control instruction information on a display unit 61 for displaying control instruction information, the operator can confirm the content of the control instruction information in real time.

Note that the position at which the content of the control instruction information is displayed is not limited to the position shown in FIG. 6, and the content of the control instruction information may be displayed at another location.

### [Apparatus Operations]

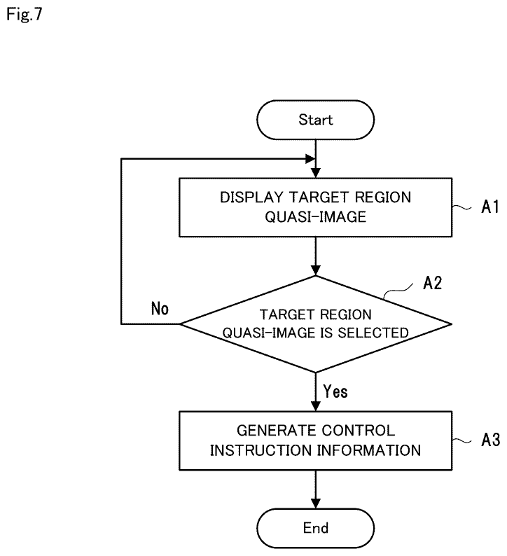

Next, operations of the observation assistance apparatus according to the example embodiment will be described with reference to FIG. 7. FIG. 7 is a diagram for describing operations of the observation assistance apparatus. In the following description, drawings will be referred to as appropriate. In addition, in the example embodiment, by causing the observation assistance apparatus to operate, an observation assistance method is performed. Thus, a description of the observation assistance method according to an example embodiment is replaced with the following description of operations of the observation assistance apparatus.

As shown in FIG. 7, the target region quasi-image generation unit 11 generates a target region quasi-image estimated to be obtained when an image of a target region is captured from a viewpoint of the observation apparatus (optical sensor) mounted in the observation satellite (the mobile body 20), and displays the target region quasi-image on the display device 50 (step A1).

Next, if the target region quasi-image is selected by the operator (step A2: Yes), the control instruction information generation unit 12 generates control instruction information based on mobile body position information and mobile body direction information that were used when the selected target region quasi-image was generated (step A3).

Note that in step A1, shadows may be added to the target region quasi-image, as described in Modified Example 1.

Note that if the target region quasi-image has not been selected by the operator yet (step A2: No), and, for example, the operator is moving the viewpoint using the input device 60 such as a mouse, a target region quasi-image corresponding to the viewpoint is generated in real time, and thus processing of step A1 is executed.

Note that in step A1, as described in Modified Example 2, the content of control instruction information may be displayed on the display device 50 along with the target region quasi-image.

### Effects of Example Embodiment

As described above, in the example embodiment and Modified Examples 1 and 2, when the operator prepares a plan for observing an image of a desired target region using the observation apparatus mounted in the mobile body, it is possible to automatically generate control instruction information that includes information required for controlling the mobile body, simply by selecting a target region quasi-image of a target region that the operator desires to observe. As a result, it is possible even for an operator who is not experienced or skilled to easily generate control instruction information.

The observation satellite moves on the path, and captures an image of the target region from a position on the path, and thus an image of the target region cannot be captured from all directions. That is to say, the direction in which an image of the target region can be captured is limited, and thus it is not necessarily possible to capture a target region quasi-image desired by the operator.

In view of this, a quasi-image of the target region captured from a viewpoint of the optical sensor mounted in the observation satellite, that is to say, a target region quasi-image corresponding to the target region that can be captured by the optical sensor is generated based on mobile body position information indicating the position of the observation satellite and map information of the target region, and is presented to the operator. In addition, each time the viewpoint is moved, a target region quasi-image is generated in real time and is presented.

As a result, the operator can intuitively obtain a desired target region quasi-image, and thus even an operator who is not experienced or skilled can easily generate control instruction information.

### [Program]

The program according to the example embodiment, the modified example 1 and the modified example 2 may be a program that causes a computer to execute steps A1 to A3 shown in FIG. 7. By installing this program in a computer and executing the program, the information processing apparatus and the information processing method according to the example embodiment, the modified example 1 and the modified example 2 can be realized. In this case, the processor of the computer performs processing to function as the target region quasi-image generation unit 11 and the control instruction information generation unit 12.

Also, the program according to the example embodiment, the modified example 1 and the modified example 2 may be executed by a computer system constructed by a plurality of computers. In this case, for example, each computer may function as any of the target region quasi-image generation unit 11 and the control instruction information generation unit 12.

### [Physical Configuration]

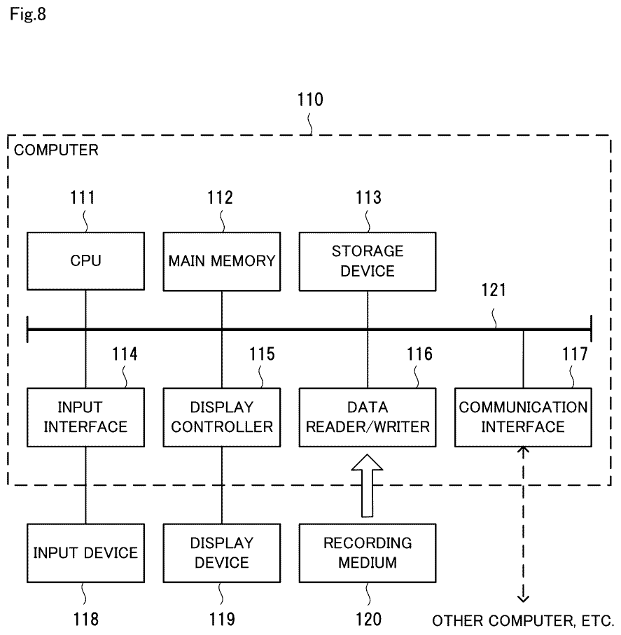

Here, a computer that realizes the observation assistance apparatus by executing the program according to an example embodiment will be described with reference to FIG. 8. FIG. 8 is a diagram illustrating an example of a computer that realizes the observation assistance apparatus in the example embodiment, the modified example 1 and the modified example 2.

As shown in FIG. 8, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU or an FPGA in addition to the CPU 111 or in place of the CPU 111.

The CPU 111 opens the program (code) according to the example embodiment, the modified example 1 and the modified example 2, which has been stored in the storage device 113, in the main memory 112 and performs various operations by executing the program in a predetermined order. The main memory 112 is typically a volatile storage device such as a DRAM (Dynamic Random Access Memory). Also, the program according to the example embodiment, the modified example 1 and the modified example 2 are provided in a state being stored in a computer-readable recording medium 120. Note that the program according to the example embodiment, the modified example 1 and the modified example 2 may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the observation assistance apparatus 10 according to the example embodiment, the modified example 1 and the modified example 2 can also be realized by using hardware corresponding to each unit. Furthermore, a portion of the observation assistance apparatus 10 may be realized by a program, and the remaining portion realized by hardware.

### SUPPLEMENTARY NOTES

Furthermore, the following supplementary notes are disclosed regarding the example embodiment, the modified example 1 and the modified example 2 described above. Some portion or all of the example embodiment, the modified example 1 and the modified example 2 described above can be realized according to (supplementary note 1) to (supplementary note 12) described below, but the below description does not limit the present invention.

### (Supplementary Note 1)

An observation assistance apparatus comprising:
a target region quasi-image generation unit that generates a target region quasi-image that shows a target region and is estimated to be obtained when an image of the target region is captured from a viewpoint of a mobile body that is equipped with an observation apparatus for observing the Earth's surface and moves along a path in a space above the Earth's surface; and
a control instruction information generation unit that generates, if the target region quasi-image is selected by an operator, control instruction information that is used for controlling at least a timing when the mobile body observes the target region, a position at which the mobile body performs observation, and a direction in which the mobile body performs observation, which are information for causing the mobile body to observe an actual observation image of the target region equivalent to the target region quasi-image, based on mobile body position information indicating a position of the mobile body and mobile body direction information indicating a direction of the mobile body that were used when the selected target region quasi-image was generated.

### (Supplementary Note 2)

The observation assistance apparatus according to Supplementary Note 1,
wherein the target region quasi-image generation unit adds a shadow image to the target region quasi-image using a timing when it is possible to observe the generated target region quasi-image, insolation information indicating an altitude and an amplitude of the sun in the target region, and three-dimensional map information of the target region.

### (Supplementary Note 3)

The observation assistance apparatus according to Supplementary Note 1 or 2,
wherein the target region quasi-image generation unit adds a shadow image to the target region quasi-image using a timing when it is possible to observe the generated target region quasi-image, weather information indicating weather in the target region, and three-dimensional map information of the target region.

### (Supplementary Note 4)

The observation assistance apparatus according to any one of Supplementary Notes 1 to 3,
wherein the target region quasi-image and the control instruction information are displayed on a display device.

### (Supplementary Note 5)

An observation assistance method to be performed by a computer, comprising:
a target region quasi-image generation step of generating a target region quasi-image that shows a target region and is estimated to be obtained when an image of the target region is captured from a viewpoint of a mobile body that is equipped with an observation apparatus for observing the Earth's surface and moves along a path in a space above the Earth's surface; and
a control instruction information generation step of generating, if the target region quasi-image is selected by an operator, control instruction information that is used for controlling at least a timing when the mobile body observes the target region, a position at which the mobile body performs observation, and a direction in which the mobile body performs observation, which are information for causing the mobile body to observe an actual observation image of the target region equivalent to the target region quasi-image, based on mobile body position information indicating a position of the mobile body and mobile body direction information indicating a direction of the mobile body that were used when the selected target region quasi-image was generated.

### (Supplementary Note 6)

The observation assistance method according to Supplementary Note 5,
in the target region quasi-image generation step of adding a shadow image to the target region quasi-image using a timing when it is possible to observe the generated target region quasi-image, insolation information indicating an altitude and an amplitude of the sun in the target region, and three-dimensional map information of the target region.

### (Supplementary Note 7)

The observation assistance method according to Supplementary Note 5 or 6,
in the target region quasi-image generation step of adding a shadow image to the target region quasi-image using a timing when it is possible to observe the generated target region quasi-image, weather information indicating weather in the target region, and three-dimensional map information of the target region.

### (Supplementary Note 8)

The observation assistance method according to any one of Supplementary Notes 5 to 7,
wherein the target region quasi-image and the control instruction information are displayed on a display device.

### (Supplementary Note 9)

A computer-readable recording medium that includes a program recording thereon, the program including instructions that cause a computer to carry out:
a target region quasi-image generation step of generating a target region quasi-image that shows a target region and is estimated to be obtained when an image of the target region is captured from a viewpoint of a mobile body that is equipped with an observation apparatus for observing the Earth's surface and moves along a path in a space above the Earth's surface; and
a control instruction information generation step of generating, if the target region quasi-image is selected by an operator, control instruction information that is used for controlling at least a timing when the mobile body observes the target region, a position at which the mobile body performs observation, and a direction in which the mobile body performs observation, which are information for causing the mobile body to observe an actual observation image of the target region equivalent to the target region quasi-image, based on mobile body position information indicating a position of the mobile body and mobile body direction information indicating a direction of the mobile body that were used when the selected target region quasi-image was generated.

### (Supplementary Note 10)

The computer-readable recording medium according to Supplementary Note 9, further causing the computer to carry out:
in the target region quasi-image generation step of adding a shadow image to the target region quasi-image using a timing when it is possible to observe the generated target region quasi-image, insolation information indicating an altitude and an amplitude of the sun in the target region, and three-dimensional map information of the target region.

### (Supplementary Note 11)

The computer-readable recording medium according to Supplementary Note 9 or 10, further causing the computer to carry out:
in the target region quasi-image generation step of adding a shadow image to the target region quasi-image using a timing when it is possible to observe the generated target region quasi-image, weather information indicating weather in the target region, and three-dimensional map information of the target region.

### (Supplementary Note 12)

The computer-readable recording medium according to any one of Supplementary Notes 9 to 11, further causing the computer to carry out:
displaying the target region quasi-image and the control instruction information on a display device.

Although the present invention of this application has been described with reference to the example embodiment, the modified example 1 and the modified example 2, the present invention of this application is not limited to the above exemplary embodiments. Within the scope of the present invention of this application, various changes that can be understood by those skilled in the art can be made to the configuration and details of the present invention of this application. This application is based upon and claims the benefit of priority from Japanese application No. 2022-051790, filed on Mar. 28, 2022, the disclosure of which is incorporated herein in its entirety by reference.

### INDUSTRIAL APPLICABILITY

As described above, it is possible to assist generation of control instruction information that is used for observation performed by a mobile body. In addition, it is useful in a field where observation using a moving body is necessary.

### LIST OF REFERENCE SIGNS

10 Observation assistance apparatus
11 Target region quasi-image generation unit
12 Control instruction information generation unit
13 communication unit
20 mobile body
30 station
40 storage device
50 display device
60 input device
70 network
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. An observation assistance apparatus comprising:
at least one memory storing instructions; and
at least one processor configured to execute the instructions to:
generate target region quasi-image that shows a target region and is estimated to be obtained when an image of the target region is captured from a viewpoint of a mobile body that is equipped with an observation apparatus for observing the Earth's surface and moves along a path in a space above the Earth's surface; and
generate, if the target region quasi-image is selected by an operator, control instruction information that is used for controlling at least a timing when the mobile body observes the target region, a position at which the mobile body performs observation, and a direction in which the mobile body performs observation, which are information for causing the mobile body to observe an actual observation image of the target region equivalent to the target region quasi-image, based on mobile body position information indicating a position of the mobile body and mobile body direction information indicating a direction of the mobile body that were used when the selected target region quasi-image was generated.

2. The observation assistance apparatus according to claim 1,
wherein the one or more processors further:
adds a shadow image to the target region quasi-image using a timing when it is possible to observe the generated target region quasi-image, insolation information indicating an altitude and an amplitude of the sun in the target region, and three-dimensional map information of the target region.

3. The observation assistance apparatus according to claim 1,
wherein the one or more processors further:
adds a shadow image to the target region quasi-image using a timing when it is possible to observe the generated target region quasi-image, weather information indicating weather in the target region, and three-dimensional map information of the target region.

4. The observation assistance apparatus according to claim 1,
wherein the target region quasi-image and the control instruction information are displayed on a display device.

5. An observation assistance method to be performed by a computer, comprising:
generating a target region quasi-image that shows a target region and is estimated to be obtained when an image of the target region is captured from a viewpoint of a mobile body that is equipped with an observation apparatus for observing the Earth's surface and moves along a path in a space above the Earth's surface; and
generating, if the target region quasi-image is selected by an operator, control instruction information that is used for controlling at least a timing when the mobile body observes the target region, a position at which the mobile body performs observation, and a direction in which the mobile body performs observation, which are information for causing the mobile body to observe an actual observation image of the target region equivalent to the target region quasi-image, based on mobile body position information indicating a position of the mobile body and mobile body direction information indicating a direction of the mobile body that were used when the selected target region quasi-image was generated.

6. The observation assistance method according to claim 5,
wherein a shadow image is added to the target region quasi-image using a timing when it is possible to observe the generated target region quasi-image, insolation information indicating an altitude and an amplitude of the sun in the target region, and three-dimensional map information of the target region.

7. The observation assistance method according to claim 5,
wherein a shadow image is added to the target region quasi-image using a timing when it is possible to observe the generated target region quasi-image, weather information indicating weather in the target region, and three-dimensional map information of the target region.

8. The observation assistance method according to claim 5,
wherein the target region quasi-image and the control instruction information are displayed on a display device.

9. A non-transitory computer-readable recording medium that includes a program recording thereon, the program including instructions that cause a computer to carry out:
generating a target region quasi-image that shows a target region and is estimated to be obtained when an image of the target region is captured from a viewpoint of a mobile body that is equipped with an observation apparatus for observing the Earth's surface and moves along a path in a space above the Earth's surface; and
generating, if the target region quasi-image is selected by an operator, control instruction information that is used for controlling at least a timing when the mobile body observes the target region, a position at which the mobile body performs observation, and a direction in which the mobile body performs observation, which are information for causing the mobile body to observe an actual observation image of the target region equivalent to the target region quasi-image, based on mobile body position information indicating a position of the mobile body and mobile body direction information indicating a direction of the mobile body that were used when the selected target region quasi-image was generated.

10. The non-transitory computer-readable recording medium according to claim 9, further causing the computer to carry out:
adding a shadow image to the target region quasi-image using a timing when it is possible to observe the generated target region quasi-image, insolation information indicating an altitude and an amplitude of the sun in the target region, and three-dimensional map information of the target region.

11. The non-transitory computer-readable recording medium according to claim 9, further causing the computer to carry out:
adding a shadow image to the target region quasi-image using a timing when it is possible to observe the generated target region quasi-image, weather information indicating weather in the target region, and three-dimensional map information of the target region.

12. The non-transitory computer-readable recording medium according to claim 9, further causing the computer to carry out:
displaying the target region quasi-image and the control instruction information on a display device.
